(19) United States
(12) Patent Application Publication
(10) Pub. No.: US 2011/0167717 A1
(43) Pub. Date: Jul. 14, 2011

(54) TREE GUARD

(76) Inventor: Kyung-Soo HAN, Seoul (KR)

(21) Appl. No.: 13/069,335

(22) Filed: Mar. 22, 2011

(30) Foreign Application Priority Data
Nov. 18, 2009 (KR) 10-2009-0111633

(51) Int. Cl. A01G 13/02

(52) U.S. Cl. 47/32

(57) ABSTRACT

A street tree guard ensuring easy assembly work and having secure coupling strength is provided. The street tree guard includes an inner supporting member which is configured to be installed on a ground around a street tree, an outer supporting member which is configured to be disposed while being spaced apart from the inner supporting member outward, a covering member which configured to be disposed between the inner supporting member and the outer supporting member. Each of the inner supporting member and the outer supporting member includes a plurality of base members configured to be disposed at equal intervals and a plurality of connecting members configured to connect two facing ends of the base members to each other. If a part of the street tree guard is damage, only the damaged part is replaced for maintenance, thereby reducing the maintenance sot. The street tree guard ensures easy installation. The street tree guard ensures simple assembly work, thereby making it easy to clean a surrounding of the street tree.

### CROSS-REFERENCE TO RELATED APPLICATION

This application claims the benefit under 35 U.S.C. §119(a) of Korean Patent Application No. 10-2009-0111633, filed on Nov. 18, 2009, the disclosure of which is incorporated by reference in its entirety for all purposes.

### BACKGROUND

1. Field

The following description relates to a tree guard, and more particularly, to a street tree guard, which is buried around a street tree to ensure easy watering of the street tree and protect the street tree and the ground of the street tree.

2. Description of the Related Art

Street trees are planted on roadways and parks to enhance the esthetic value of surroundings and provide a pleasant environment. However, such street trees, which are planted in places where many people and vehicles pass, are easily damaged. In addition, the street trees may be pulled out by their roots due to natural disasters including heavy rainfall, heavy snow and typhoons.

A street tree guard serves as a fence for defining a boundary between the ground where the street trees are planted and a roadway and for preventing the earth from being washed out by a passerby or heavy rainfall. In addition, the street tree guard is installed to prevent the street trees from being damaged by external force and help the trunk of the street trees to grow straight.

In general, the street tree guard is installed around the street trees and buried at a predetermined depth from a ground level, and is provided in a square shape. Such a street tree guard is installed on a busy sidewalk having many passersby and thus a part of the street tree guard may be easily subject to damage. In this case, the whole assembly of the street tree guard needs to be replaced rather than replacing only the damaged part, and this increases the maintenance cost of the street tree guard.

In general, a single assembly member of the street tree guard is formed of metal or wood to provide strength against external forces. Accordingly, the weight of even a single assembly member is too heavy to be carried by a worker, thereby requiring many workers or additional equipment to lift the assembly member.

In addition, the street tree guard needs to maintain secure assembly state to resist against external forces.

### SUMMARY

In one aspect, there is provided a street tree guard, capable of ensuring easy maintenance.

In another aspect, there is provided a street tree guard, capable of ensuring easy assembly work and having secure coupling strength.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a perspective view illustrating an example of a street tree guard installed around a street tree.

FIG. 2 is an exploded perspective view illustrating an outer supporting member of the street tree guard shown in FIG. 1.

FIGS. 3 and 4 are plan views illustrating another example of a street tree guard.

FIG. 5A is a perspective view illustrating a coupling structure of a base member and a connecting member shown in FIG. 2.

FIG. 5B is a perspective view illustrating another example of a connecting member.

FIG. 5C is a perspective view illustrating another example of a connecting member.

FIG. 6 is a vertical cross sectional view of the street tree guard shown in FIG. 1.

FIG. 7 is a plan view illustrating still another example of a street tree guard.

FIG. 8 is a vertical cross sectional view of the street tree guard shown in FIG. 7.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

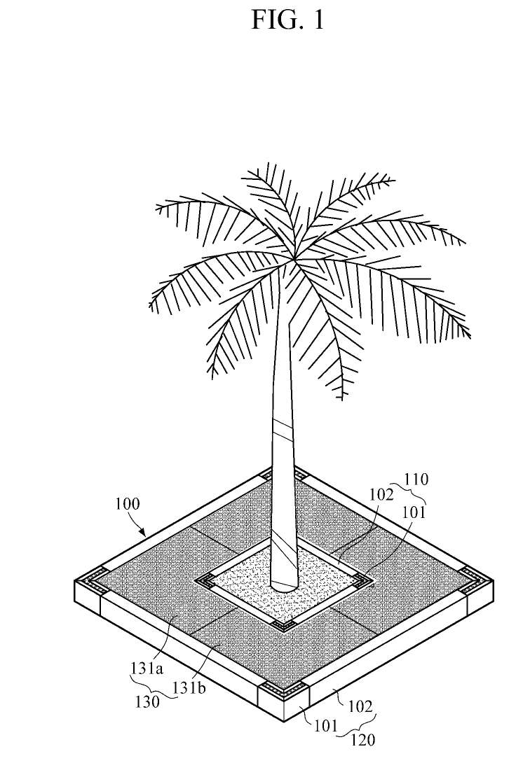

FIG. 1 is a perspective view illustrating an example of a street tree guard installed around a street tree.

As shown in FIG. 1, a street tree guard 100 includes an inner supporting member 110, an outer supporting member 120 and a covering member 130. The inner supporting member 110 is installed on the ground around a street tree. The outer supporting member 120 is spaced apart from the inner supporting member 110 outward. The covering member 130 is disposed between the inner supporting member 110 and the outer supporting member 120. Each of the inner supporting member 110 and the outer supporting member 120 includes a plurality of base members 101 and a plurality of connecting members 102.

The base members 101 are disposed at equal intervals lengthwise along the outer supporting member 120 or the inner supporting member 110. The base members 101 may be formed of wood, metal and plastic. Using plastic as the material of the base member 101 reduces the manufacturing cost of the weight of the street tree guard 100 and ensures easy processing of the weight of the street tree guard 100. When metal is used as the material of the base member 101, it is preferable to use stainless steel which does not cause erosion due to moisture. However, the material of the base member 101 is not limited to thereto, and may be implemented as any material capable of resisting against erosion.

The connecting member 102 connects two facing ends of different base members 101 to each other. As the connecting member 102 connects the two facing ends of the base members 101, the outer supporting member 120 and the inner supporting member 110 form a looped curve shape around the street tree in cooperation with each other. Details of a coupling structure of the base member 101 and the connecting member 102 will be described later.

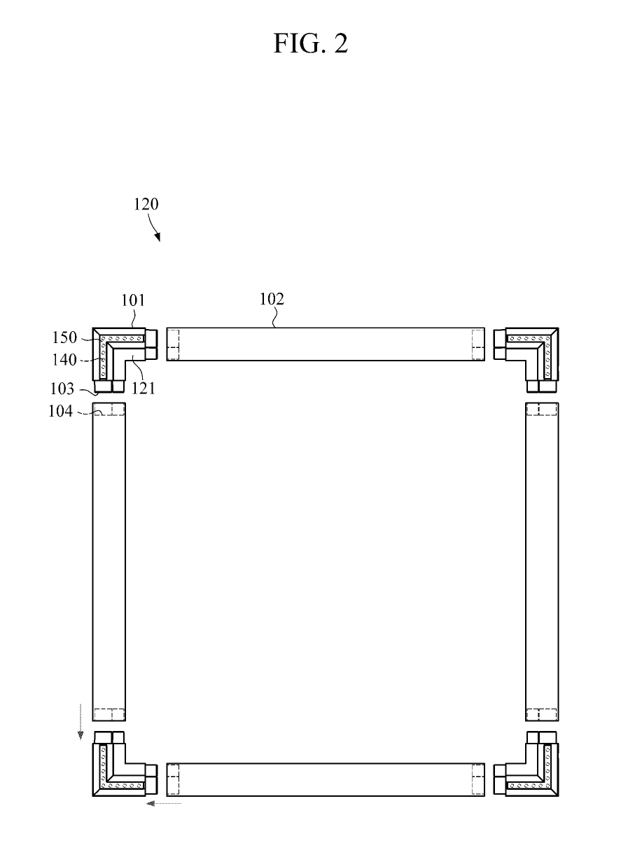

As shown in FIG. 2, the street tree guard 100 is formed through assembly of the plurality of base members 101 and connecting members 102 and thus easy to assemble, so that the time required for installing the street tree guard 100 is reduced. In addition, the street tree guard 100 is easy to disassemble, thereby facilitating cleaning a surrounding environment of the street trees. In addition, if a part of the street tree guard 100 is damaged, only the damaged part is replaced rather than replacing the whole street tree guard 100, thereby reducing the cost required for maintenance. In addition, the increase of the number of base members 101 and the connecting members further secures the coupling strength of the street tree guard 100.

Although not shown, at least one of the inner supporting member 110 and the outer supporting member 120 may be provided in a polygonal shape. For example, the inner supporting member 110 may be provided in a square shape, and the outer supporting member 120 may be provided in a pentagonal shape. For example, the inner supporting member 110 may be provided in a pentagonal shape and the outer supporting member 120 may be provided in an octagonal shape. For example, both of the inner supporting member 110 and the outer supporting member 120 may be provided in an octagonal shape or a pentagonal shape.

In this case, the base member 101 is bent to form a predetermined inside angle and disposed on each angular point of the polygon of the inner supporting member 110 or the outer supporting member 120. For example, if the inner supporting member 110 is provided in a square shape, the base member 101 is bent to form a 90-degree angle and disposed at each angular point of the square, and then the connecting member 102 connects the base members 101. If the inner supporting member 110 is provided in a pentagonal shape, the base member 101 is bent to form a 72-degree angle and disposed at each angular point of the pentagon, and then the connecting member 102 connects the base member 101.

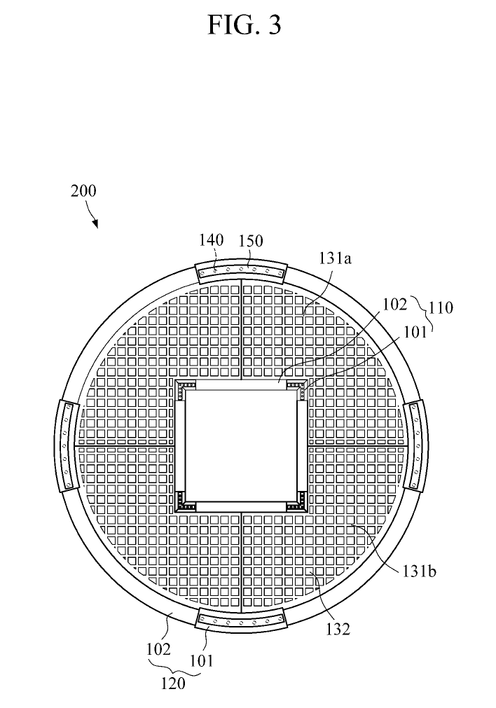

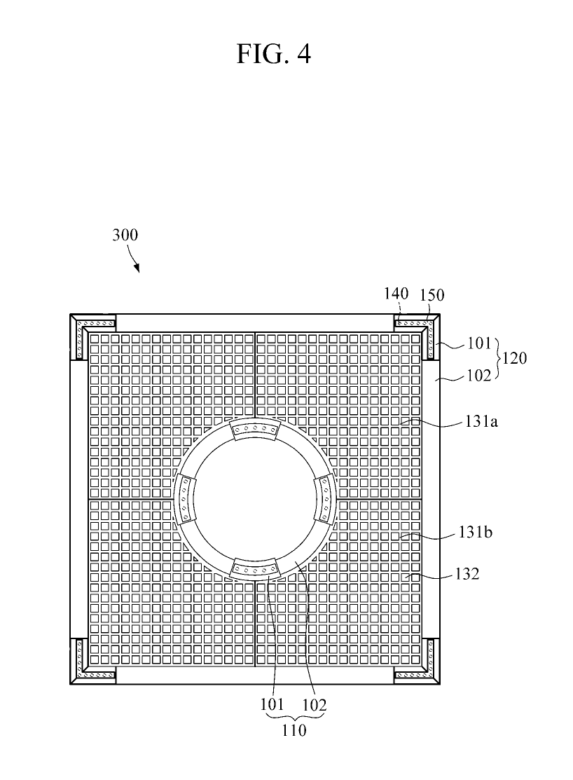

Unlike the above description, as shown in FIGS. 3 and 4, at least one of the inner supporting member 110 and the outer supporting member 120 may be provided in a circular shape. For example, as shown in FIG. 3, the inner supporting member 110 may be provided in a polygonal shape and the outer supporting member 120 may be provided in a circular shape. In addition, as shown in FIG. 4, the inner supporting member 110 may be provided in a circular shape and the outer supporting member 120 may be provided in a polygonal shape. In addition, both of the inner supporting member 110 and the outer supporting member 120 may be provided in a circular shape. At least one of the inner supporting member 110 and the outer supporting member 120 is provided in a circular shape. In this case, the base member 101 and the connecting member 102 may have the same curvature. Alternatively, the base member 101 and the connecting member 102 may have different curvatures such that the inner supporting member 110 and the outer supporting member 120 are provided in an elliptical shape.

In a case where the inner supporting member 110 is provided in a circular shape and four base members 101 are used, the base members 101 are disposed at intervals of 90 degrees in the circle. When three base members 101 are used, the base members 101 are disposed at intervals of 120 degrees in the circle. The shape of the street tree guard 100 is not limited thereto and may be implemented in various forms.

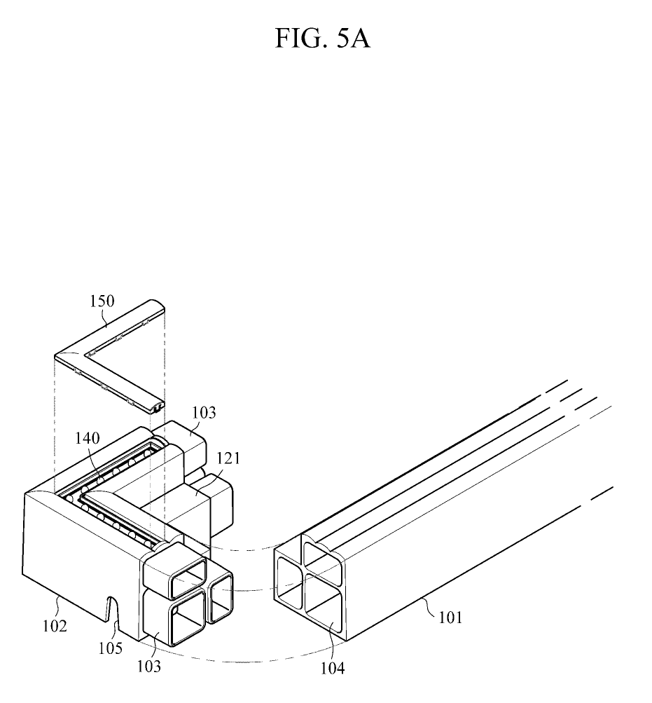

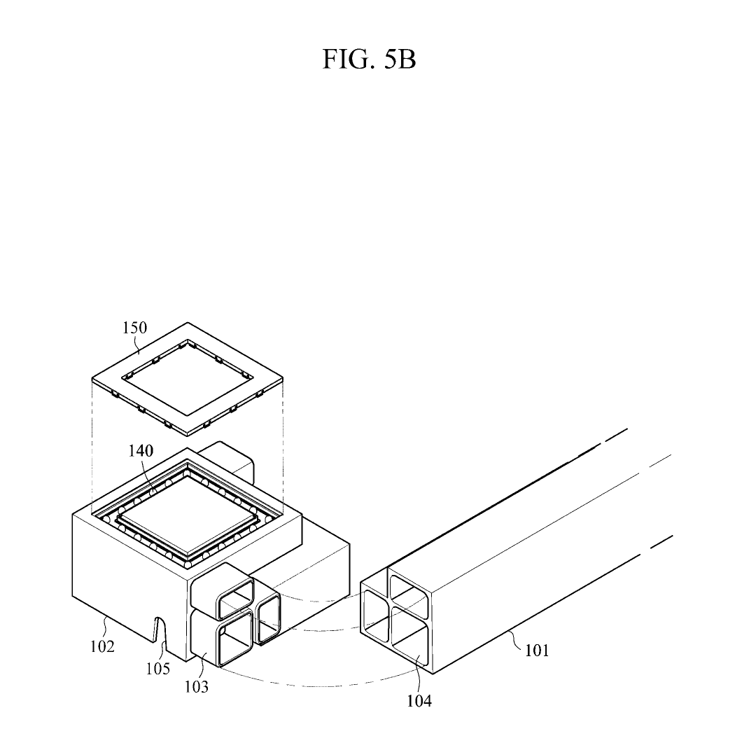

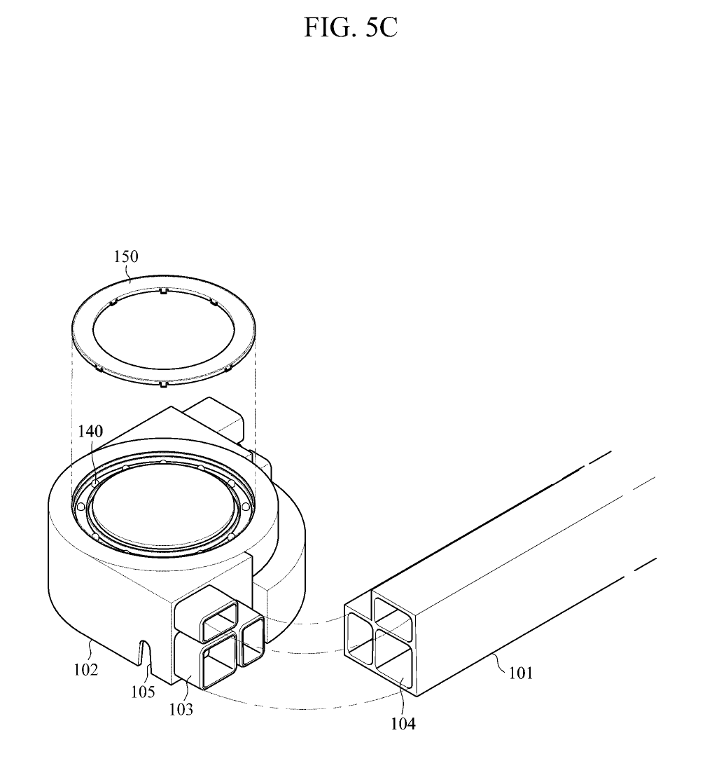

FIG. 5A is a perspective view illustrating a coupling structure of a base member and a connecting member shown in FIG. 2.

Hereinafter, the coupling structure of the base member 101 and the connecting member 102 will be described with reference to FIG. 5A.

One of the base member 101 and the connecting member 102 includes a protrusion part 103, and the other of the base member 101 and the connecting member 102 includes an accommodating part 104. The protrusion part 103 protrudes from one side of the one of the base member 101 and the connecting member 102 in a predetermined length. The accommodating part 104 is recessed inward from one side of the one of the base member 101 and the connecting member 102, facing the protrusion part 103, in a predetermined length to accommodate the protrusion part 103. As the base member 101 is coupled to the connecting member 102, the protrusion part 103 is accommodated in the accommodating part 104.

For example, if the protrusion part 103 is formed at each end of the base member 101, the accommodating part 104 is formed at each end of the connecting member 102. Alternatively, the protrusion part 103 is formed at one end of the base member 101 and the accommodating part 104 may be formed at the other end of the base member 101.

The protrusion parts 103 may be provided in plural to increase a contact area with respect to the accommodating part 104 compared to when the protrusion part is only one. In this regard, the coupling strength between the base member 101 and the connecting member 102 is increased. In addition, it is preferable that the protrusion part 103 is press fitted to the accommodating part 104 to improve the coupling strength between the base member 101 and the connecting member 102. Such a coupling structure secures the stability of the street tree guard 100 installed on the ground and maintains its assembled state secure.

Meanwhile, at least one of the base member 101 and the connecting member 102 may include at least one light emitting device 140. Such a light emitting device 140 may be disposed on a mounting groove formed on at least one of the base member 101 and the connecting member 102. The mounting groove is recessed from a surface of the base member 101 or the connecting member 102 downward in a predetermined depth and extends lengthwise along the base member 101 or the connecting member 102. The light emitting device 140 may be disposed to emit light in a direction vertical to the ground or toward the street trees. The light emitting device 140 serves to lighten the street trees, thereby enhance the esthetic value of the surroundings.

The mounting grove may be air-tightened by a cover 150. The cover 150 is configured to protect the light emitting device 140 against external substances or impact. The cover 150 may be formed of a transparent material allowing light to pass therethrough. In addition, the cover 150 may be provided in a predetermined color, allowing light of the light emitting device 140 passing through the cover 140 to take on the predetermined color. In addition, an inner surface or an outer surface of the cover 150 have a wrinkled part to diffuse light of the light emitting device 140. For example, the light emitting device 140 may be implemented as a light emitting diode (LED). Such an LED has the ability to emit light with a low level of power and save the power consumption of the street tree guard 100. Meanwhile, if the light emitting device 140 is disposed on the base member 101, the base member 101 may be provided at one side thereof with an opening 105 which allows a power supply line to pass therethrough from the outside.

Meanwhile, as shown in FIGS. 5B and 5C, the connecting member 102 may be provided in a square shape or in a circular shape.

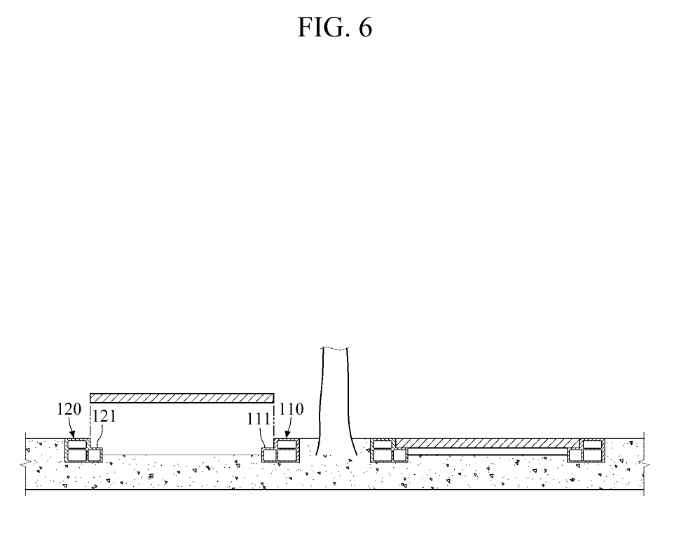

Hereinafter, the structures of the inner supporting member 110, the outer supporting member 120 and the covering member 130 will be described in detail with reference to FIG. 6.

As shown in FIG. 6, the inner supporting member 110 is provided in a shape corresponding to the shape of the outer supporting member 120 and disposed inside the outer supporting member 110. The inner supporting member 110 includes a first stepped portion 111. The first stepped portion 111 is formed around the outer circumference of the inner supporting member 110 at a predetermined height from the bottom surface of the inner supporting member 110.

The outer supporting member 120 serves as an outer boundary of the street tree guard 100 on the ground. The outer supporting member 120 includes a second stepped portion 121. The second stepped portion 121 is formed around an inner circumference of the outer supporting member 120 at a predetermined height from the bottom surface of the outer supporting member 120 while facing the first stepped portion 111.

The covering member 130 may be provided in a plate shape. One end of the covering member 130 is mounted on the first stepped portion 111 and the other end of the covering member 130 is mounted on the second stepped portion 121. The covering member 130 is formed with a plurality of holes 132 (see FIG. 3) to easily discharge rainfall or moisture to the street trees. The covering member 130 is mounted on the first stepped portion 111 and the second stepped portion 121 and thus prevents the inner supporting member 110 and the outer supporting member 120 from being distorted or separated due to external force. In addition, the covering member 130 is mounted on the first stepped portion 111 and the second stepped portion 121, and thus not causes a problem of being buried by solid. Accordingly, the soil underneath the covering member 130 is prevented from being washed out and water introduced to the street tree guard 100 is effectively discharged.

Such a structure facilitates installation and separation of the street tree guard 100, thereby reducing the time required for installation. In addition, if a part of the inner supporting member 110, the outer supporting member 120 and the covering member 130 is damaged by external force, only the damaged part is separated from the street tree guard 100, thereby reducing the time required for maintenance.

Referring again to FIG. 1, the covering member 130 may be formed of a plurality of unit covering parts 131a and 131b. If foreign substances such as trash are introduced through the hole (132 in FIG. 3), a unit covering part 131a of the covering member 130 is separated from the street tree guard 100 to easily remove the foreign substance. In addition, when some part of the covering member 130 is damaged by external force, only some unit covering parts 131a and 131b corresponding to the damaged part are replaced for maintenance, thereby reducing the maintenance cost.

In addition, the covering member 130 includes a plurality of unit covering parts 131a and 131b having the same shape. Accordingly, the covering member 130 is formed using a single mold smaller than a mold used to form an integral type covering member. The plurality of covering parts 131a and 131b are manufactured in a single mold and the covering member 130 is formed by assembling the manufactured covering parts 131a and 131b. In this manner, the cost required to manufacture the covering member 130 is reduced.

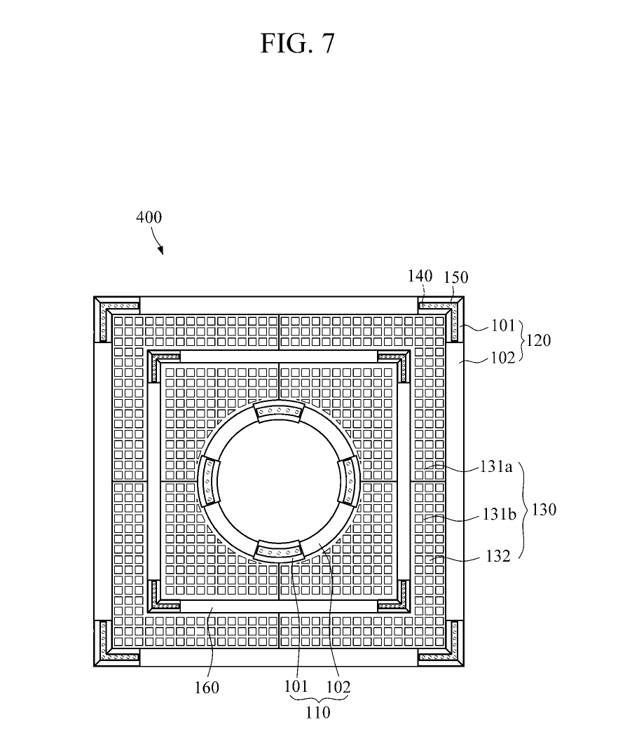

FIG. 7 is a plan view illustrating still another example of a street tree guard. As shown in FIG. 7, a street tree guard 400 for a larger street tree may further include an auxiliary supporting member 160. In this case, the street tree guard 400 has a larger size and also the covering member 130 has a larger size compared to a general street tree guard. The covering member 130 is divided into a larger number of covering parts and the auxiliary supporting member 160 is disposed between the inner supporting member 110 and the outer supporting member 120. Accordingly, the covering member 130 is more stably supported by the auxiliary supporting member 160, ensuring stability of the covering member 130 against external force.

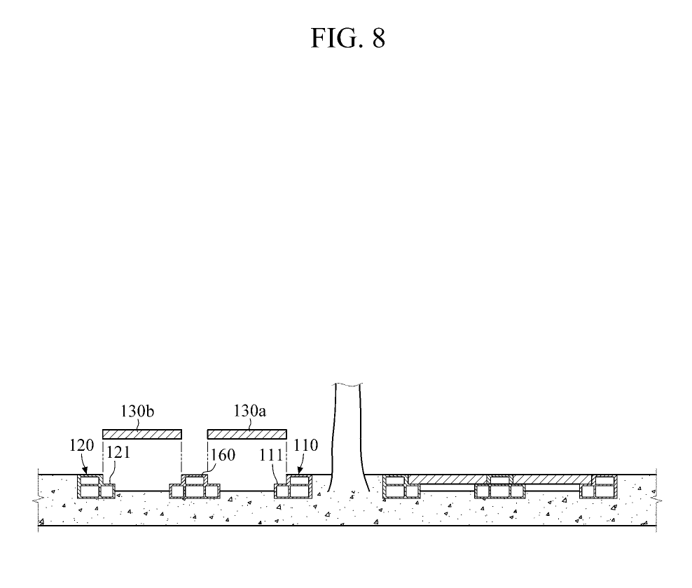

FIG. 8 is a vertical cross sectional view of the street tree guard shown in FIG. 7. As shown in FIG. 8, the auxiliary supporting member 160 may be provided at an inner circumference and an outer circumference thereof with a stepped portion. The covering part 130a is mounted on the first stepped portion 111 of the inner supporting member 110 and the second stepped portion formed on the inner circumference of the auxiliary supporting member 160. The covering part 130b is mounted on the second stepped portion 121 of the outer supporting member 120 and the stepped portion formed on the outer circumference of the auxiliary supporting member 160.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A street tree guard comprising:
an inner supporting member which is configured to be installed on a ground around a street tree;
an outer supporting member which is configured to be disposed while being spaced apart from the inner supporting member outward;
a covering member which configured to be disposed between the inner supporting member and the outer supporting member,
wherein each of the inner supporting member and the outer supporting member includes a plurality of base members configured to be disposed at equal intervals and a plurality of connecting members configured to connect two facing ends of the base members to each other.

2. The street tree guard of claim 1, wherein at lest one of the inner supporting member and the outer supporting member is provided in a polygonal shape, and the base member is bent to form a predetermined inside angle to be disposed at each angular point of the polygonal shape.

3. The street tree guard of claim 1, wherein at least one of the inner supporting member and the outer supporting member is provided in a circular shape.

4. The street tree guard of claim 1, wherein one of the base member and the connecting member has a protrusion part protruding from one side of the one of the base member and the connecting member in a predetermined length, and
the other of the base member and the connecting member has an accommodating part recessed inward from one side of the one of the base member and the connecting member, facing the protrusion part, in a predetermined length to accommodate the protrusion part.

5. The street tree guard of claim 1, wherein the inner supporting member includes a first stepped portion which is formed around an outer circumference of the inner supporting member at a predetermined height from a bottom surface of the inner supporting member, and
the outer supporting member includes a second stepped portion which is formed around an inner circumference of the outer supporting member at a predetermined height from a bottom surface of the outer supporting member while facing the first stepped portion,
wherein the covering member is provided in a plate shape and has a first end mounted on the first stepped portion and a second end mounted on the second stepped portion.

6. The street tree guard of claim 5, wherein the covering member includes a plurality of unit covering parts.

7. The street tree guard of claim 1, wherein at least one of the base member and the connecting member includes at least one light emitting device.
